(19) United States
(12) Patent Application Publication
(10) Pub. No.: US 2024/0034837 A1
(43) Pub. Date: Feb. 1, 2024

(54) Linear polymers comprising dibenzocyclooctene-based moieties having tunable coefficients of thermal expansion

(71) Applicant: National Technology & Engineering Solutions of Sandia, LLC, Albuquerque, NM (US)

(72) Inventors: Jeffrey C. Foster, Albuquerque, NM (US); Erica M. Redline, Albuquerque, NM (US); Chad L. Staiger, Albuquerque, NM (US); Koushik Ghosh, Albuquerque, NM (US); Eric M. Nagel, Albuquerque, NM (US)

(21) Appl. No.: 18/101,629

(22) Filed: Jan. 26, 2023

Related U.S. Application Data
(60) Provisional application No. 63/304,396, filed on Jan. 28, 2022.

(51) Int. Cl. C08G 73/06; C08G 69/26; C08G 63/199

(52) U.S. Cl. CPC C08G 73/0694; C08G 69/26; C08G 63/199

(57) ABSTRACT

Linear polymers and copolymers having tunable coefficients of thermal expansion can be derived from dibenzocyclooctene-based monomers. The dibenzocyclooctene-based monomer can comprise a dibenzocyclooctene or a heterocyclic derivative of dibenzocyclooctene. For example, the linear polymer can comprise a polymer or copolymer of a dibenzocyclooctene-based moiety and a polyester, polyamide, polyimide, polyurethane, or epoxy.

### CROSS-REFERENCE TO RELATED APPLICATION

This application claims the benefit of U.S. Provisional Application No. 63/304,396, filed Jan. 28, 2022, which is incorporated herein by reference.

### STATEMENT OF GOVERNMENT INTEREST

This invention was made with Government support under Contract No. DE-NA0003525 awarded by the United States Department of Energy/National Nuclear Security Administration. The Government has certain rights in the invention.

### FIELD OF THE INVENTION

The present invention relates to polymers with tunable coefficients of thermal expansion and, in particular, to linear polymers comprising dibenzocyclooctene-based moieties having tunable coefficients of thermal expansion.

### BACKGROUND OF THE INVENTION

Dibenzocyclooctene (DBCO, also referred to as dibenzocyclooctane) and derivatives thereof have been shown to be useful organic compounds to manipulate the thermal expansion behavior of polymer networks (e.g., cured epoxies). As illustrated in FIG. 1, a strategy to manipulate the coefficient of thermal expansion (CTE) of polymers involves covalent incorporation of thermally contractile units, such as DBCO, within the polymer structure. DBCO, comprising a flexible cyclooctene ring connecting two rigid phenyl or aromatic groups, undergoes a reversible twist-boat to chair isomerization upon heating accompanied by a decrease in molecular volume. See X. Shen et al., Nat. Chem. 5(12), 1035 (2013); Z. Wang et al., Macromolecules 51(4), 1377 (2018); and W. Fu et al., J. Am. Chem. Soc. 142(39), 16651 (2020). These conformational “shrinking” linkages oppose thermal expansion during heating, with the net effect of reducing the CTE of the polymer to near or less than zero in some cases.

Recently, the DBCO moiety has been used to prepare di-aniline crosslinkers for use in epoxy/amine thermosets. See U.S. application Ser. No. 17/344,717, filed Jun. 10, 2021, which is incorporated herein by reference. Depending on the regioisomer (or positional isomer) of cis-diamino-DBCO utilized as a crosslinker, epoxy thermosets were prepared with near-zero, or in some cases negative, CTE values that feature highly reversible thermal expansion and contraction behavior. However, these DBCO compounds are difficult to access from a synthetic perspective.

### SUMMARY OF THE INVENTION

The present invention is directed to linear polymers or copolymers comprising dibenzocyclooctene-based moieties having a tunable coefficient of thermal expansion. The invention is further directed to a method of synthesizing a linear polymer or copolymer having a tunable coefficient of thermal expansion, comprising providing a dibenzocyclooctene-based monomer having functionality on both aromatic rings, and reacting the dibenzocyclooctene-based monomer with itself or at least one other monomer. The invention is further directed to a method of synthesizing a linear polymer having a tunable coefficient of thermal expansion, comprising providing a Tröger's base precursor polymer and reacting the precursor polymer with methyl iodide followed by alkaline hydrolysis, whereby the bicyclic amine of the Tröger's base undergoes a ring opening, thereby providing a copolymer comprising a Tröger's base and a benzodiazacyclooctene.

### BRIEF DESCRIPTION OF THE DRAWINGS

The detailed description will refer to the following drawings, wherein like elements are referred to by like numbers.

FIG. 1 is a schematic illustration of thermally controlled isomerization of DBCO between twist-boat and chair conformers.

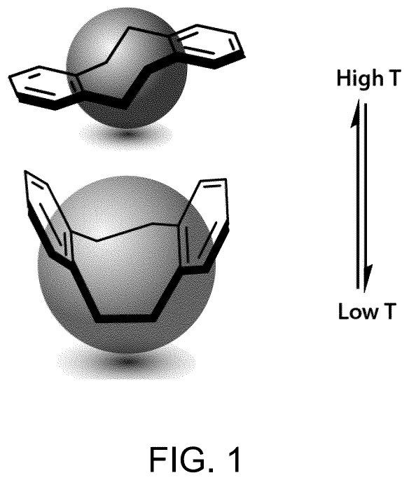

FIG. 2 is an illustration of generalized monomer and linear polymer structures comprising DBCO-based moieties.

FIG. 3A shows a synthetic route to prepare diamino-DBCO (DADBCO). FIG. 3B shows a second synthetic route to DADBCO.

FIG. 4 shows a synthetic route to dicarboxy-dibenzocyclooctene.

FIG. 5 shows examples of two different dioxy DBCO-based moieties, di(dimethylamino) substituted dibenzo[b,f][1,5]dioxocin and a di(dimethylamino) substituted dibenzo[b,f][1,4]dioxocin.

FIG. 6A shows a synthetic route to 2,2′-diamino-dibenzo[b,f][1,5]dioxocin. FIG. 6B shows a synthetic route to 2,3′-diamino-dibenzo[b,f][1,4]dioxocin. FIG. 6C shows a synthetic route to 2,2′-diamino-dibenzo[b,f][1,4]dioxocin and 2,3′-diamino-dibenzo[b,f][1,4]dioxocin.

FIG. 7 shows exemplary linear polymers that can be derived from DBCO and monomers and precursor polymers.

FIG. 8 is an illustration of linear polymers that can be derived from Tröger's base-type monomers.

FIG. 9 is an illustration of a method to synthesize a DBCO-containing copolymer derived from poly(Tröger's base).

### DETAILED DESCRIPTION OF THE INVENTION

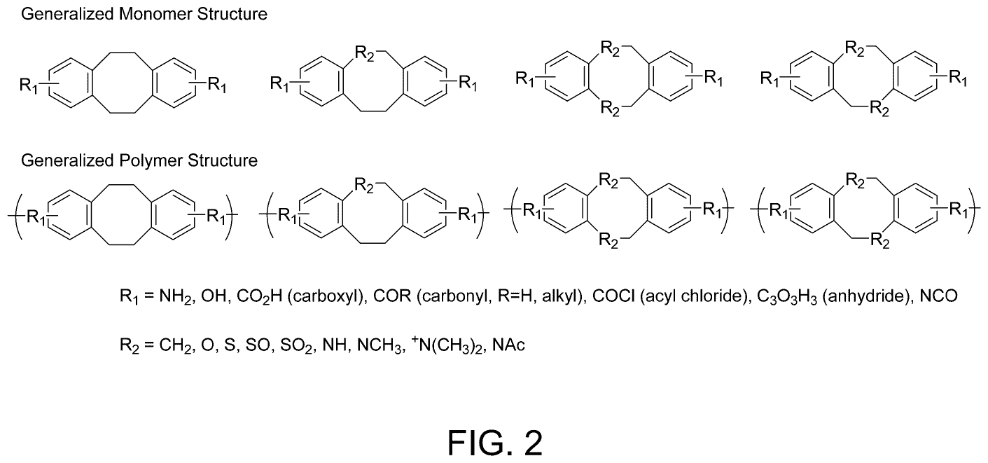

Linear polymers and copolymers can be derived from DBCO-based monomers. Linear polymers have advantages due to the fact that they can be readily purified, characterized using solution-based techniques, and easily and repeatedly processed. FIG. 2 illustrates exemplar monomer and linear copolymer structures comprising DBCO-based moieties. The polymers can be synthesized via step-growth copolymerization between a functionalized DBCO monomer and itself or at least one other monomer. To obtain a linear polymer, the DBCO monomer is preferably difunctional (same functionality on both aromatic rings) and can have any type of substitution pattern around the aromatic rings. Alternatively, the DBCO monomer can have different functionality on each of the rings. For example, the functionality R₁ can comprise an amino (NH₂), hydroxyl (OH), carboxyl (COOH), acyl chloride (COCl), carbonyl (COH, COR), anhydride (C₃O₃H₃), epoxide (C₃O₂H₆), or isocyanate (NCO) group. The DBCO monomer further comprises a cyclooctene ring or heterocyclic derivatives thereof fused to the aromatic end groups, thereby providing high conformational flexibility. For example, the heterocyclic derivative can incorporate one or more heterogroups (R₂), including oxy (O), thio (S), sulfoxyl (SO), sulfonyl (SO₂), amino (NH), methylamino (NCH₃), dimethylammonium (⁺N(CH₃)₂), or N-acylamide (NAc).

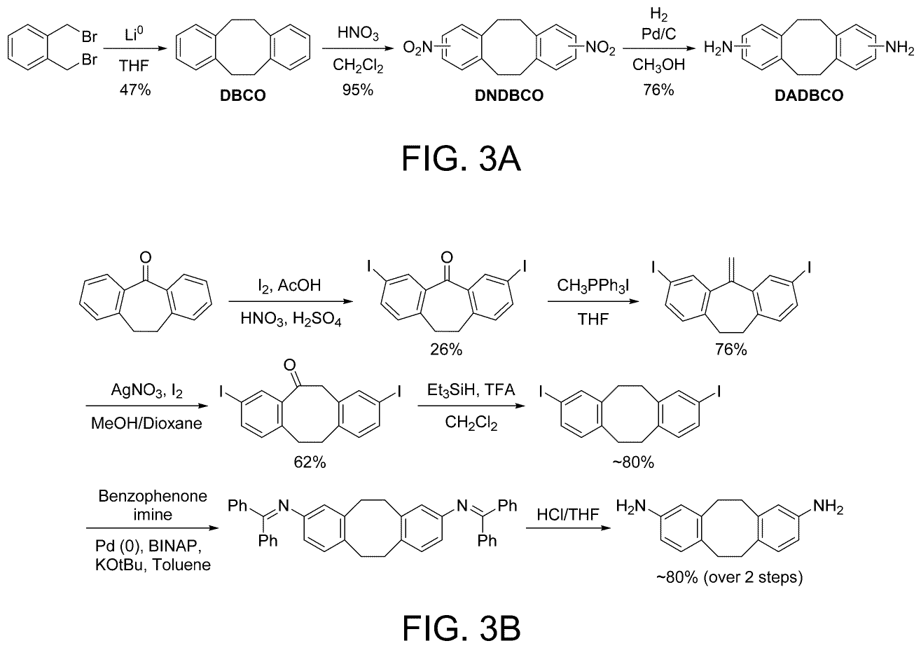

Epoxy thermoplastics can be prepared from epoxide-functionalized resins and difunctional crosslinkers such as dianhydrides or diamines. FIG. 3A shows a three-step synthetic route to prepare a diamino-DBCO (DADBCO) curative. In the first step, α,α′-dibromo-o-xylene is dimerized in the presence of elemental Li to form a DBCO scaffold. See G. Franck et al., Org. Syn. 89, 55 (2012). Soft nitration of DBCO with excess HNO₃ in CH₂Cl₂ provides the dinitro derivative (DNDBCO). See A. G. Giumanini et al., Ind. Eng. Chem. Res. 41(8), 1929 (2002). All six of the possible regioisomers are obtained during the nitration step in approximately equal abundance (the ratio of ortho/meta nitro substituents was 2:3). In the final step, DNDBCO is hydrogenated under standard conditions to yield a mixture of DADBCO regioisomers. The trans- and cis-DADBCO regioisomers can be isolated from the DADBCO isomer mixture via exhaustive chromatography.

Alternatively, the DADBCO regioisomer shown in FIG. 3B can be prepared in six steps from dibenzosuberone. The diiodination reaction and subsequent Wittig-Prevost ring expansion sequence on dibenzosuberone have been previously described by Kardelis et al. See V. Kardelis et al., Angew. Chem. Int. Ed. 55(3), 945 (2016). Reduction of the ketone to the methylene in the ring expanded compound is accomplished using triethylsilane/trifluoracetic acid. Palladium catalyzed amination of the diiodinated DBCO with benzophenone imine followed by deprotection of the amine using HCl_{(aq)}/THF gives the DADBCO regioisomer as an off white solid.

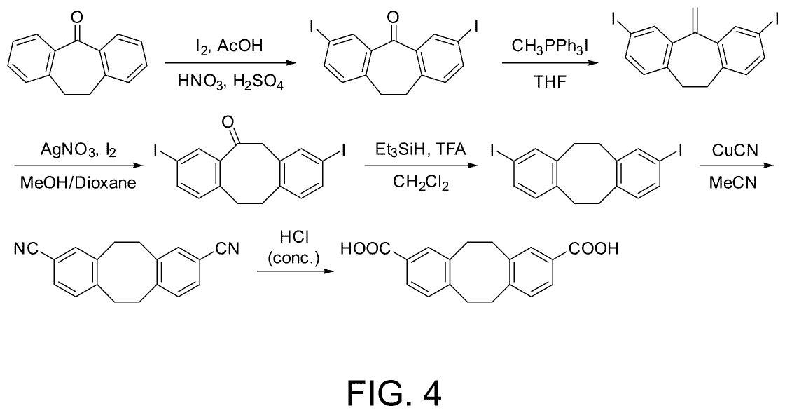

The dicarboxy-dibenzocyclooctene derivative shown in FIG. 4 can be prepared in six steps and shares the same di(iodobenzo)cyclooctene intermediate as in the DADBCO regioisomer synthesis described above. Di(iodobenzo)cyclooctene may be reacted with copper(I) cyanide in acetonitrile to give the dinitrile intermediate. Hydrolysis of the dinitrile intermediate with HCl_{(aq)} gives the dicarboxy-dibenzocyclooctene monomer.

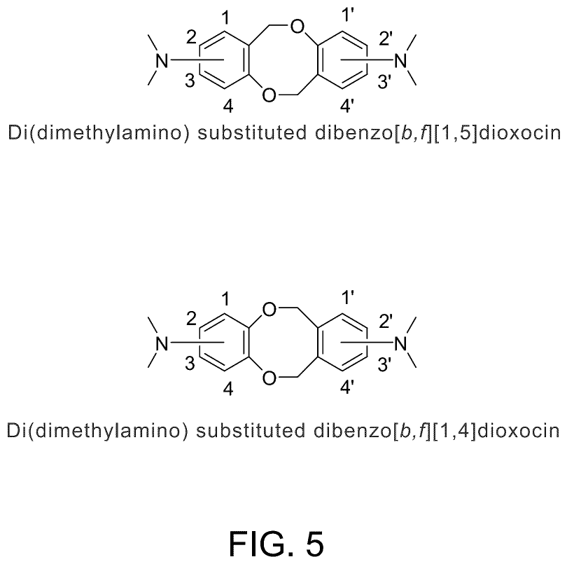

FIG. 5 shows examples of two different dioxy heterocycles, a di(dimethylamino) substituted dibenzo[b,f][1,5]dioxocin and a di(dimethylamino) substituted dibenzo[b,f][1,4]dioxocin.

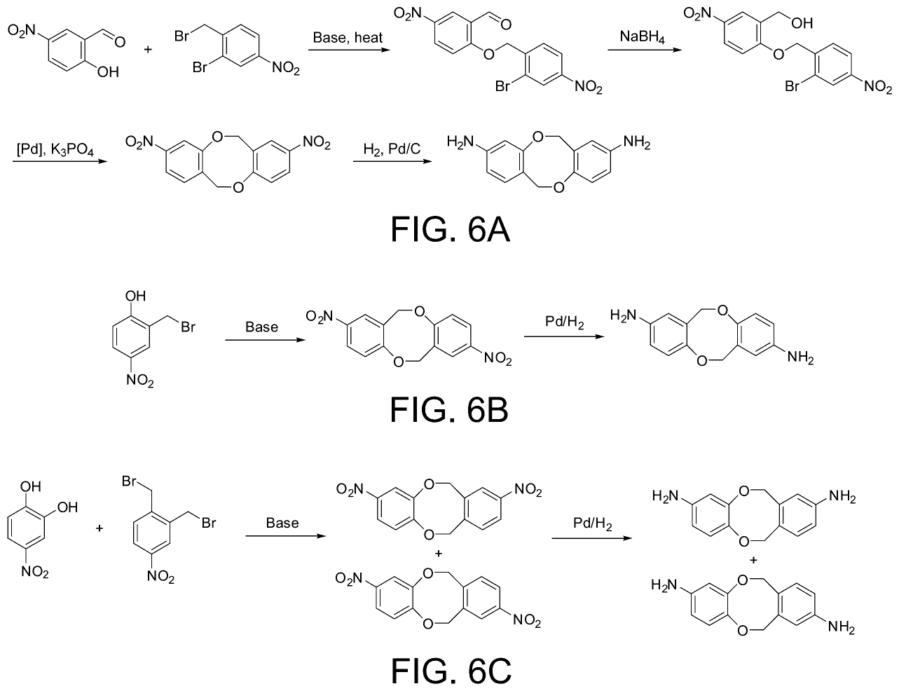

The synthesis of 2,2′-diamino-dibenzo[b,f][1,5]dioxocin shown in FIG. 6A begins with the base promoted reaction of 5-nitrosalicylaldehyde and 2-bromo-1-(bromomethyl)-4-nitrobenzene to give the ether. Reduction of the aldehyde with NaBH₄ followed by Pd catalyzed cyclization gives the dinitro dioxocin intermediate. Reduction of the nitro groups using H₂ and Pd/C gives 2,2′-diamino-dibenzo[b,f][1,5]dioxocin monomer.

The synthesis of 2,3′-diamino-dibenzo[b,f][1,4]dioxocin shown in FIG. 6B begins with the base promoted etherification/cyclization of 2-hydroxy-5-nitrobenzyl bromide. Reduction of the nitro groups in the cyclized product using H₂ and Pd/C gives the 2,3′-diamino-dibenzo[b,f][1,4]dioxocin monomer.

The synthesis of 2,2′-diamino-dibenzo[b,f][1,4]dioxocin and 2,3′-diamino-dibenzo[1,4]dioxocin shown in FIG. 6C begins with the base promoted reaction of 4-nitrocatechol with 2-bromo-1-(bromomethyl)-4-nitrobenzene to give the cyclized diethers. Reduction of the nitro groups using H₂ and Pd/C gives 2,2′-diamino-dibenzo[b,f][1,4]dioxocin and 2,3′-dimethyl-dibenzo[b,f][1,4]dioxocin monomers.

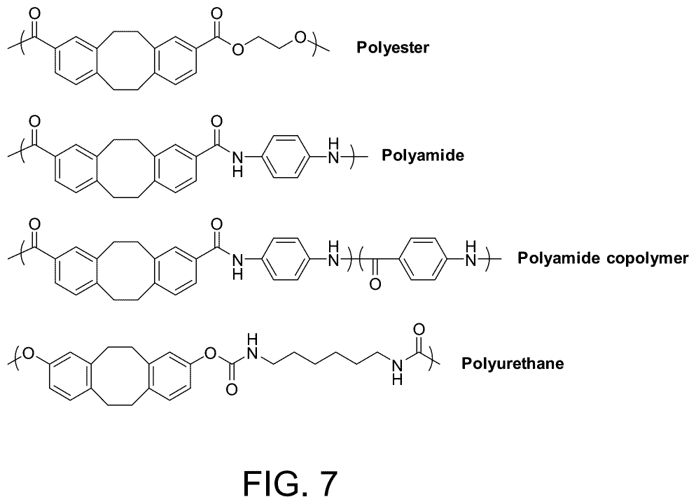

FIG. 7 shows exemplary linear polymers that can be derived from DBCO and monomers and precursor polymers. Types of thermoplastic polymer and copolymer structures that can contain the DBCO-based moiety include polyester, polyamide, polyimide, polyurethane, and epoxy (linear).

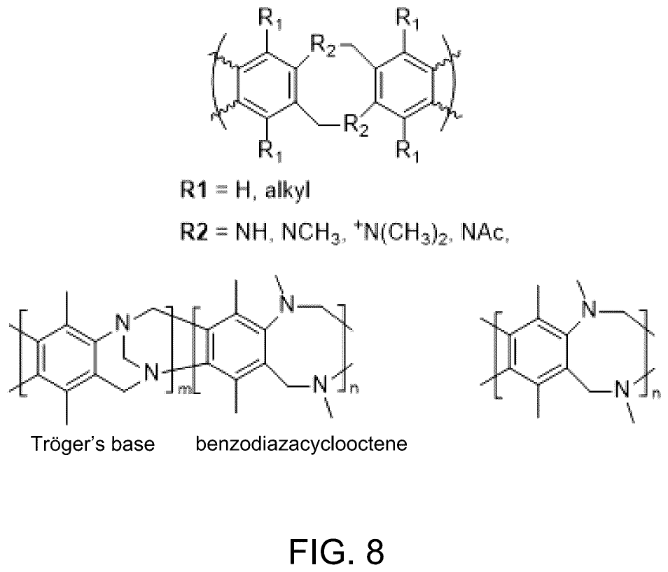

FIG. 8 shows exemplary linear polymers that can be derived from Tröger's base-type monomers and precursor polymers

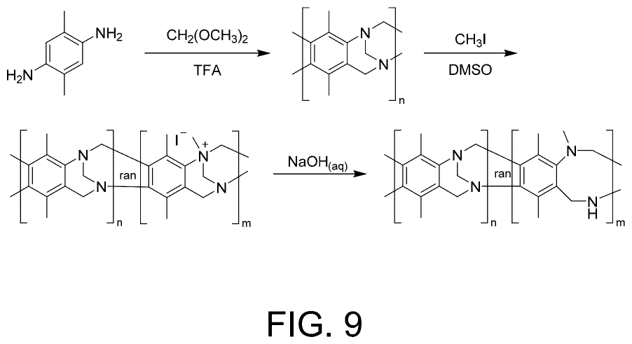

FIG. 9 shows an exemplary synthesis of a DBCO-containing copolymer derived from a poly(Tröger's base). See K. Inoue et al., ChemNanoMat 7, 824 (2021). Tröger's base precursor polymers can be synthesized from 1,4-dianilines. As an example, diethoxymethane (16 mL, 180 mmol) and 2,5-dimethyl-1,4-benzenediamine (5.0 g, 37 mmol) were added to trifluoracetic acid (80 mL) that had been cooled to 0° C. The solution was allowed to warm to room temperature and stirred for an additional 6 days. The solution was then poured into ice cold water and then the pH of the solution was adjusted to 9 by the addition of aqueous NH₄OH. The precipitated solids were collected by vacuum filtration and washed with water. The precipitated solids were then dried under vacuum at 70° C. to give the Tröger's base precursor polymer.

The Tröger's base precursor polymer undergoes ring opening of the bridged Tröger's base unit upon N-methylation followed by alkaline hydrolysis, resulting in a ladder-like copolymer that contains benzodiazacyclooctene. As an example, the Tröger's base precursor polymer (0.5 g, 2.2 mmol) and iodomethane (1.4 mL, 22 mmol) were combined in DMSO (10 mL). The solution was heated to 50° C. and stirred for 3 days. The solution was cooled to room temperature and poured into water to precipitate a solid. The solid was washed with additional water and methanol. The solid was dried under vacuum at 30° C. to give the N-methylated Tröger's base polymer. The N-methylated Tröger's base polymer was suspended in 1 M NaOH (15 mL) at room temperature and stirred overnight. The solution was filtered to collect the solids and the solids were washed with water. The solids were dried under vacuum at room temperature to give the Tröger's base/benzodiazacyclooctene copolymer. The benzodiazacyclooctene units can exhibit a ring-flipping motion. Copolymers with various min ratios, and therefore different CTEs, can be prepared depending on the reaction conditions.

The present invention has been described as to linear polymers comprising dibenzocyclooctene-based moieties having tunable coefficients of thermal expansion. It will be understood that the above description is merely illustrative of the applications of the principles of the present invention, the scope of which is to be determined by the claims viewed in light of the specification. Other variants and modifications of the invention will be apparent to those of skill in the art.

We claim:

1. A linear polymer comprising a dibenzocyclooctene-based moiety having a tunable coefficient of thermal expansion.

2. The linear polymer of claim 1, wherein the dibenzocyclooctene-based moiety comprises dibenzocyclooctene.

3. The linear polymer of claim 1, wherein the dibenzocyclooctene-based moiety comprises a heterocyclic derivative of dibenzocyclooctene.

4. The linear polymer of claim 3, wherein the heterocyclic derivative comprises an oxy, thio, sulfoxyl, sulfonyl, amino, methylamino, dimethylammonium, or N-acylamide heterogroup.

5. The linear polymer of claim 1, wherein the linear polymer comprises a polymer or copolymer of the dibenzocyclooctene-based moiety and a polyester, polyamide, polyimide, polyurethane, or epoxy.

6. The linear polymer of claim 1, wherein the linear copolymer comprises a copolymer of a Tröger's base and a benzocyclooctene-based moiety.

7. The linear polymer of claim 6, wherein the benzocyclooctene-based moiety comprises benzodiazacyclooctene.

8. A method of synthesizing a linear polymer having a tunable coefficient of thermal expansion, comprising:
providing a dibenzocyclooctene-based monomer having functionality on each of the aromatic rings; and
reacting the dibenzocyclooctene-based monomer with at least one other monomer to provide a linear polymer or copolymer having dibenzocyclooctene-based moieties.

9. The method of claim 8, wherein the functionality comprises an amino, hydroxyl, carboxyl, acyl chloride, carbonyl, anhydride, epoxide, or isocyanate group.

10. A method of synthesizing a linear polymer comprising having a tunable coefficient of thermal expansion, comprising:
providing a Tröger's base precursor polymer; and
reacting the precursor polymer with methyl iodide followed by alkaline hydrolysis, whereby the bicyclic amine of the Tröger's base undergoes a ring opening, thereby providing a copolymer comprising a Tröger's base and a benzodiazacyclooctene.
